(19) United States
(12) Patent Application Publication
(10) Pub. No.: US 2017/0202293 A1
(43) Pub. Date: Jul. 20, 2017

(54) ANSI approved rechargeable, lighted, blue tooth hardhat

(71) Applicant: Harold Eugene Rossi, JR., Aurora, IL (US)

(72) Inventor: Harold Eugene Rossi, JR., Aurora, IL (US)

(21) Appl. No.: 14/997,959

(22) Filed: Jan. 18, 2016

(51) Int. Cl. A42B 3/04; F21V 5/04; F21V 7/00; F21V 15/01; A42B 3/30; F21V 23/04; F21V 23/00; H04R 1/10; H02J 7/02; F21L 4/02; F21V 33/00

(52) U.S. Cl. CPC A42B 3/0446; F21L 4/02; F21V 5/04; F21V 7/00; F21V 15/01; F21V 33/0008; F21V 23/04; F21V 23/003; H04R 1/1083; H02J 7/025; A42B 3/30; F21Y 2115/10

(57) ABSTRACT

A hardhat that is rechargeable with controlled lighting and Bluetooth. The hardhat itself can be designed many ways while comprised of, but not limited to, High impact resistant plastic, Fiberglass, and or carbon fiber. The hardhat includes a sub-shell in which the front LED lights, rear LED strobe lights, blue tooth system, speakers, microphone, ear bud jack, magnetic ear bud holders, and controls for the lighting and blue tooth. The hardhat's Front LED lights have one or more lenses for selective optimal lighting. The embodiment also has an upper strobe light that works in tandem with the rear red strobe lights intermittently. The hard hat meets ANSI safety requirements. A charging device such as, but not limited to, a wireless charging station, wall mounted, integrated hat rack. Ear buds or ear muffs engineered to limit construction noise, and permit sound travel from speaker to ear. A retrofit unit comprising: a sub-shell, front LED lights, rear strobe lights, blue tooth system, speakers, ear bud jacks, magnetic ear bud holders, controls for lighting and blue tooth, top LED strobe light with High Impact Resistant Plastic. Retrofit unit also supports, and is not limited to, the engineered ear buds, ear muffs, and or the wireless charging station. The retrofit unit can be installed permanently with many popular style hard hats being used.

### CROSS-REFERENCE TO RELATED APPLICATIONS

U.S. PATENTS DOCUMENTS

| | | |
|---|---|---|
| 3,302,018 | Issued Jan. 31, 1967 | Harding |
| 3,676,664 | Issued Jul. 11, 1972 | Corvertti |
| 4,199,802 | Issued Apr. 22, 1980 | Malm |
| 4,231,079 | Issued Oct. 28, 1980 | Heminover |
| D298476 | Issued Nov. 8, 1988 | Lonnstedt |
| D300868 | Issued Apr. 25, 1989 | Conforti |
| 4,945,458 | Issued Jul. 31, 1990 | Batts, et al. |
| D318338 | Issued Jul. 16, 1991 | Mitchell |
| 5,329,637 | Issued Jul. 19, 1994 | Walker |
| 5,408,393 | Issued Apr. 18, 1995 | Becker |
| 5,426,792 | Issued Jun. 27, 1995 | Murasko |
| 5,564,128 | Issued Oct. 15, 1996 | Richardson |
| 5,688,039 | Issued Nov. 18, 1997 | Johnson |
| 5,758,947 | Issued Jun. 2, 1998 | Glatt |
| 5,810,467 | Issued Sep. 22, 1998 | Hurwitz |
| 5,836,673 | Issued Nov. 17, 1997 | Lo |
| 6,244,721 | Issued Jun. 12, 2001 | Rodriguez, et al. |
| 6,325,521 | Dec. 4, 2001 | Gregg, et al. |
| 6,328,454 | Dec. 11, 2001 | Davis |
| 6,575,588 | Jun. 10, 2003 | Strehl |
| 6,609,913 | Aug. 26, 2003 | Batts |
| 7,075,250 | Jul. 11, 2006 | Colwell |
| 7,121,676 | Oct. 17, 2006 | Kutnyak |
| 7,206,429 | Apr. 17, 2007 | Vossler |
| 7,304,442 | Dec. 4, 2007 | Colwell |
| 7,311,413 | Dec. 25, 2007 | Barnes |
| 7,690,806 | Apr. 6, 2010 | Feinbloom, et al. |
| 7,784,935 | Aug. 31, 2010 | Jackson, et al. |
| 7,715,888 | May 11, 2010 | Ko |
| 8,015,626 | Sep. 13, 2011 | Grassl, et al. |
| 8,025,432 | Sep. 27, 2011 | Wainright |
| 8,117,676 | Feb. 21, 2012 | Cardoso |
| 8,902,315 | Dec. 2, 2014 | Fisher, et al. |
| 9,042,944 | May 26, 2015 | Dieringer |
| 8,688,040 | Apr. 1, 2014 | Jung |
| 9,103,539 | Aug. 11, 2015 | Baker |

U.S. PATENT APPLICATION PUBLICATIONS

| | | |
|---|---|---|
| 20020159250 | Oct. 31, 2002 | Kuo, Yin Jyh; et al. |
| 20030067769 | Apr. 10, 2003 | Gilpin, Scott |
| 20040090769 | May 13, 2004 | Milton, William Allen |
| 20040227628 | Nov. 18, 2004 | Burdick, Joshua |
| 20050174753 | Aug. 11, 2005 | Cao, Densen; et al. |
| 20090073679 | Mar. 19, 2009 | Wainright; Lee |
| 20120224356 | Sep. 6, 2012 | FISCHER; TROY; et al. |
| 20130217370 | Aug. 22, 2013 | Gerald; Rajhon; et al. |

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### REFERENCE TO A MICROFICHE APPENDIX

Not applicable.

### SEQUENCE LISTING

Not applicable.

### STATEMENT REGARDING PRIOR DISCLOSURES BY THE INVENTOR OR A JOINT INVENTOR

Not applicable.

### BACKGROUND OF THE INVENTION

The present invention relates to an improved illumination device, charging system, including a blue tooth system, and improved ear buds and for helmets and hardhats, which are worn in poor lighted conditions, while engaging in activities, to perform various tasks.

Description of Related Art Including Information Disclosed Under 37 C.F.R. 1.97 And 1.98

In the past, various devises such as head lamps, protective helmets or hardhats, have been equipped with lamps to illuminate the general area in which they are performing an activity.

Cao et al., US 20050174753, discloses a mining light having a semiconductor light source such as an LED or laser, a heat sink, a magnetic switch, a light reflective and focusing cone, and other features.

Milton, US 20040090769, discloses a bicycle helmet with small safety lights built into the outer rim of the helmet.

Kuo et al., US 20020159250, discloses a safety hat having a plurality of soft or hard light emitting strips, and a control switch. The hat body is like a shade. The soft light emitting strips are adhered on the surface and two lateral sides of the hat body. The battery is formed on the soft light emitting strips. One end of the control switch is connected to an electrode of the battery, and another end thereof is connected to the power supply end of the light emitting strip. By the action of the control switch, the soft light emitting strip lights up or becomes extinguished.

Baker, U.S. Pat. No. 9,103,539 discloses a light-emitting system is provided which is removably attachable to headgear for personal illumination to enhance visibility of the user to others. The light-emitting system includes a housing that defines a receiving aperture and is configured to surround a portion of the headgear when the light-emitting system is removably attached to the headgear for use. The light-emitting system further includes at least one lens and a plurality of lighting elements coupled to the annular housing which are configured to selectively generate a halo or at least a partial halo of light that radiates outwardly away from the annular housing through the at least one lens to provide enhanced personal illumination.

Dieringer, U.S. Pat. No. 9,042,944, discloses a communication system for a user having a helmet including earphones and a microphone and including a two-way radio and a microphone-including unit carried by the user and connected to the two-way radio includes a sensor for sensing the presence of the user's head within the helmet.

Barnes, U.S. Pat. No. 7,311,413, discloses a lighting device for use with a helmet, having a fastening site and a plurality of lamps. A base member is employed and includes at least one support holding at least one lamp. A flexible sheath extends over the support, the lamp, and at least a portion of the base member to form an enclosure. The sheath possesses an opening to allow light to pass from the lamp to the exterior of the sheath. The sheath also includes an outer surface of frictional material to allow the sheath to be frictionally fixed in at least a first and second position at the surface of the helmet. A fastener links the sheath to the helmet.

Davis, U.S. Pat. No. 6,328,454, discloses a lighting device for a safety helmet or the like used for recreational and industrial purposes wherein a plurality of blinking LEDs are disposed on the outer surface of the helmet. The only circuitry needed is a 3 volt battery, an On-Off Switch and wiring for interconnecting the LEDs.

Gregg et al., U.S. Pat. No. 6,325,521, discloses a circuit on a curved surface where the circuit includes at least one circuit element on the curved surface, at least one conductive path on, and integral with, the curved surface, where the conductive path is connected to the circuit element, and circuitry for supplying power along the conductive path to the circuit element. The curved surface may be a helmet, in which case a plurality of pairs of light emitting elements may be provided thereon where the pairs emit light sequentially one pair at a time in order to maximize the brightness of the light emitted and maximize battery life. Also, a receiver for an infrared or ultrasonic signal may be provided such that the light emitting elements emit light in a certain manner as a result of the signal being received. Also provided is a method of forming at least one conductive path on a curved surface, such as on a helmet, where the method comprises aiming a beam of light to the curved surface, providing relative movement between the beam of light and the curved surface causing the beam of light to form a path on the curved surface, and laying conductive material on the path. The beam of light may be aimed at a mirror which bends the beam of the light to the curved surface, and the mirror may be moved by a stepper motor controlled by a computer. In addition, the curved surface may be moved by a stepper motor controlled by the computer.

Rodriguez et al., U.S. Pat. No. 6,244,721, discloses an automatic illuminated helmet comprising at least one light source that is automatically activated by an activation device. The activation device is a pressure switch located within the helmet. In this design, as the switch contacts the user's head, the light source will be activated. Hence, when the helmet is worn, activation will occur. In an alternative embodiment, a photovoltaic panel is used to re-charge the power supply.

Hurwitz, U.S. Pat. No. 5,810,467, discloses an illuminated protective hat including at least one eletroluminescent lamp secured to a shell of the protective hat, which is powered by a power unit housed in a power unit portion of the protective hat shell, where the power unit includes a rechargeable battery. A retrofit unit including at least one electroluminescent lamp and power unit portion, to retrofit existing protective hats with the electroluminescent lamp and power unit portion. Both the electroluminescent lamp and the power unit portion of the retrofit unit can be either permanently or temporarily secured to a protective hat.

Glatt, U.S. Pat. No. 5,758,947, discloses an illuminated safety helmet including a protective core and a first layer disposed on the protective core. The first layer is a substrate or an impact resistant shell. A plurality of light emitting diodes and traces for electrically connecting the light emitting diodes are disposed on the substrate or impact resistant shell. As such, when the substrate or impact resistant shell is disposed on the core, the light emitting diodes are automatically disposed around the protective core. The illuminated safety helmet also includes control circuitry for illuminating the light emitting diodes and a power source for powering the control circuitry and the light emitting diodes.

Johnson, U.S. Pat. No. 5,688,039, discloses that a safety helmet has a battery operated, flashing rear light for wide angle visibility and a battery operated front light with a narrow projected forward beam to light the path being traversed. The front light pivots about a horizontal axis with manual control to adjust the attitude or inclination of the beam to enhance its utility.

Walker, U.S. Pat. No. 5,329,637, discloses that the present invention relates to an improved fireman's helmet which includes a surrounding wall structure that defines a head receiving area therein. Mounted within the head receiving area and recessed in the wall structure are front and rear light assemblies as well as a battery pack and control panel.

Heminover, U.S. Pat. No. 4,231,079, discloses an article of wearing apparel such as a rigid opaque hat which has light emitting diodes mounted therein for being viewed, the terminals of the diodes and the circuitry for controlling the same being concealed within the article of apparel or on the person of the wearer. Control circuitry includes an electronic clock which sends electric pulses to an electronic counter, the output of which passes through a decoder which controls which diodes are sequentially illuminated to create an illusion of motion for getting the attention of others or for providing a type of theatrical ornamentation for the user.

However, workers such as policemen, firefighters, construction workers, road construction, railroad workers, miners, disaster teams and the like, not only need to see the poor lighted area but need to be seen themselves. Accidents have statistically related back to the lack of visibility as the cause of preventable accidents. Safety provisions such as high visibility vests, gloves that have reflective stripes attaches to the articles to improve the visibility of the workers themselves are more common now. The vest, with reflective tape, only help when light is directed at the reflective tape itself, whereas a strobe light flashing is quite noticeable regardless of what time, day, or night it is.

The prior related art clearly presents the need for this present invention that will significantly impact the safety of workers, first by providing an improved forward illumination light, second by increasing their visibility with strobe lights, both in which will be able to last throughout the work day for longer periods of time, while enjoying music or a short conversation on the phone via blue tooth, an improved charging system, making it more efficient and easier to charge.

### BRIEF SUMMARY OF THE INVENTION

The present invention has considerable improvements over the disadvantages of prior related art as said. 1) This invention has a sleek design incorporating the power supply within its overall look to the actual hardhat. There is not a box attached that has the batteries inside for a power source as was for other above mentioned objects. The power supply is more than sufficient for prolonged use over great periods of time. 2) The sleek design incorporates all of the components whereas prior protective hats have bulky objects attached to them, creating something to get snagged on while working in certain conditions, such as ceiling work, for instance, with many pipes, wires, ceiling grid, ductwork and the like in the close proximity of the actual hat, sometimes making it necessary to remove safety hat for the moment. 3) The sub-shell design that enables the LED lights not only to be placed more closely to the line of sight of the user, but also to ensure the integrity of the hardhat itself for meeting ANSI requirements. The sub-shell design also protects the integrated components from getting damaged. Some above mentioned prior art interferes with the structural integrity through fastening lamps to or within placement of said lamps and vents. The sub-shell design also enables retrofit models for various types while still maintaining structural integrity of actual hard hat as a whole. 4) Front LED lights have a high output for nice clear lighting abilities and require minimal energy which makes for longer use. Some of the Prior objects mentioned above are capable to illuminate in front of work area, however the illumination may be poor if not initially then over a short period of time. 5) The strobe LED's at the top and rear, alternate between themselves with a few short bursts of each before rotating to the other, enables battery life to increase with minimal energy demands and increasing the number of times more likely to get noticed. The rear strobe lights are red because it associates commonly with the rear, with vehicles and the like, worldwide. Some Prior art related above had blinking lights not with the strobe action. 6) Blue tooth capabilities with speaker and microphone. Being able to listen to music and make a phone call hands free while performing activities. Previous objects mention above use a two-way radio with Bluetooth technology to establish communication. 7) Engineered ear buds that block out construction noise and enable sound to travel from speaker to ear through a hollowed shaft. 8) Magnetic ear bud holders that are part of the sub-shell. 9) Removable battery packs incorporated within the design of the unit. 10) Wireless charging capabilities, either desktop or wall mounted integrated hat rack.

This present invention is made from pure necessity. From the improved power source, and improved charging devices. Combined with the efficient LED lights, Front powerful LED lights that multiply forward illumination with productivity, and rear/top strobe LED lights that protect individuals from preventable injuries with higher visibility, creates a whole new level of illuminated light. Add a touch of modern convenience with some music, and phone conversations, that you will be able to hear better with the improved ear buds or ear muffs, multi task hands free via blue tooth, and that's the brief summary of this modern invention.

### BRIEF DESCRIPTION OF THE SEVERAL VIEWS OF THE DRAWING

NOTE: hard hats are typically worn with the front bill towards the front of the head also known as front facing forward type. There are individuals that wear the hard hat reversed so the bill is towards the back, which then is referred to a rear facing forward type. The present invention has, but is not limited to, three front LED lights; therefore how the lights and controls are integrated depict which way the hardhat is used (front facing forward or rear facing forward) . . . . Additionally among the following designs the batteries are located differently depending on shell design.

FIG. 1 is a top view of a heavy duty shell design

FIG. 2 is a side view capturing the front of a heavy duty shell design that is a rear facing forward type

FIG. 3 is a side view capturing the rear of a heavy duty shell design that is a rear facing forward type

FIG. 4 is a top view of a heavy duty shell showing internal components that is a rear facing forward type

FIG. 5 is a side view capturing the front of a full brimmed hard hat

FIG. 6 is an underside view showing the controls and internal components of a full brimmed hardhat

FIG. 7 is a side view capturing the rear of a smooth top design of a rear facing forward type

FIG. 8 is a side view capturing the front of a smooth top design of a rear facing forward type

FIG. 9 is an underside view of a smooth top design, rear facing forward, showing components within

FIG. 10 is a top view of a smooth top design

FIG. 11 is a front facing forward type with a heavy duty shell design, internal components shown

FIG. 12 is an underside view of a front facing forward type with a smooth shell design, internal components shown.

FIG. 13 is a section view of the top strobe LED

FIG. 14 is a retrofit version, components shown

FIG. 15 is a removable battery pack

FIG. 16 is a set of ear buds specially designed to block construction noise while enabling sound to travel from speaker to ear

FIG. 17 is a front view of hardhat with hearing protection ear muffs with speakers to block out construction noise but enable sound to heard from speaker

FIG. 18 is an ear plug for noise protection designed with the ability to enable sound to travel within

FIG. 19 is a wireless charging hat rack station shown with present invention

### DETAILED DESCRIPTION OF THE INVENTION

For the purposes of clarity, these expressed details in the following will avoid going on tangents, clouding up the body of this disclosure of the present invention, limiting the description only to that of the present invention 30 and will not digress in each and every part of its content, since someone with the knowledge of such devices will know that clearly the present invention could limit one or more such details within the following descriptions and still keep the essence and functions of its intended purpose of this invention.

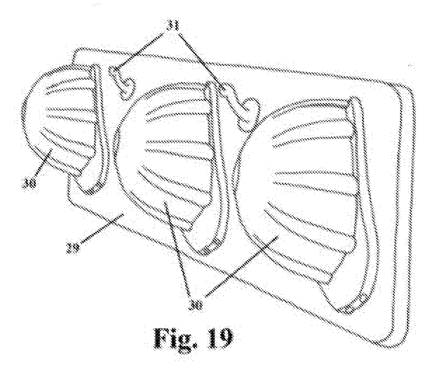

In the following detailed descriptive guidelines, someone who is familiar with manufacturing such parts and or pieces would be pleased to discover that this present invention, and all of its relevant parts, is not limited solely to that of construction protective helmets. Perhaps the sleek design that also incorporates the power source, powerful lighting and strobe lights with the sub-shell design, ear buds or even the wireless charging hat racks, could be provided in other aspects, such as but not limited to bicycle helmets, or firefighters helmets. Clearly, without any doubts, the sleek protective shell, lighting capabilities with sub-shell design could be useful. Whereas the wireless charging hat rack (FIG. 19) would be irreplaceable in a firefighters lifestyle needs. To be able to wirelessly charge your protective hat and when that emergency arises to grab your protective hat and head out to work without losing or unplugging wires or adapters. Let it be known that truly this present invention 30 and all of its content is quite adaptable in variety of ways.

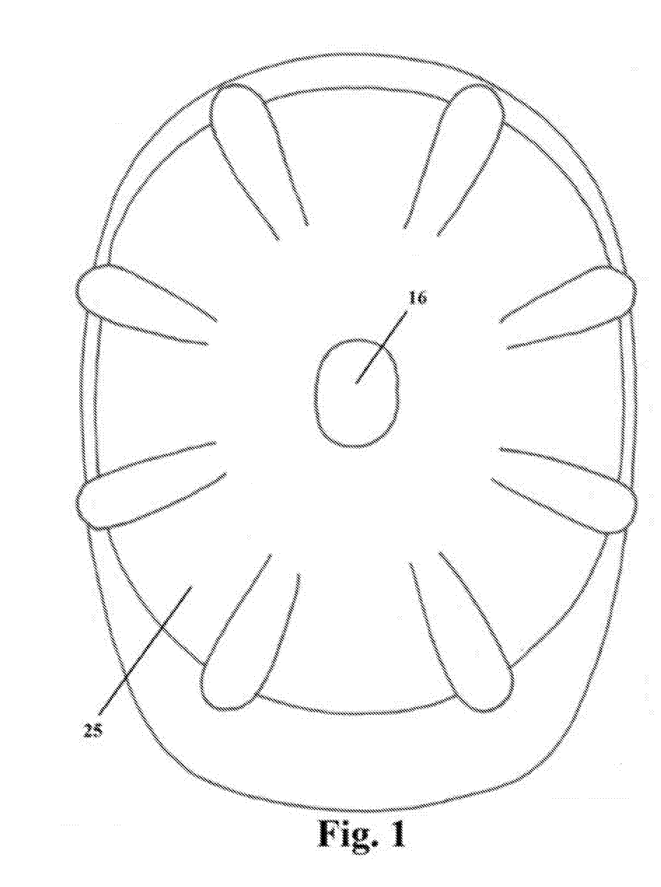

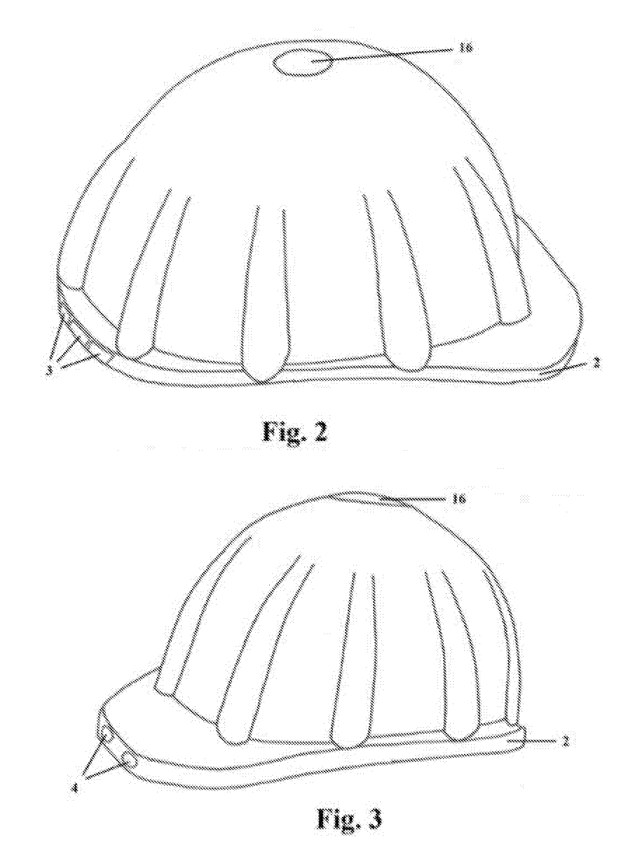

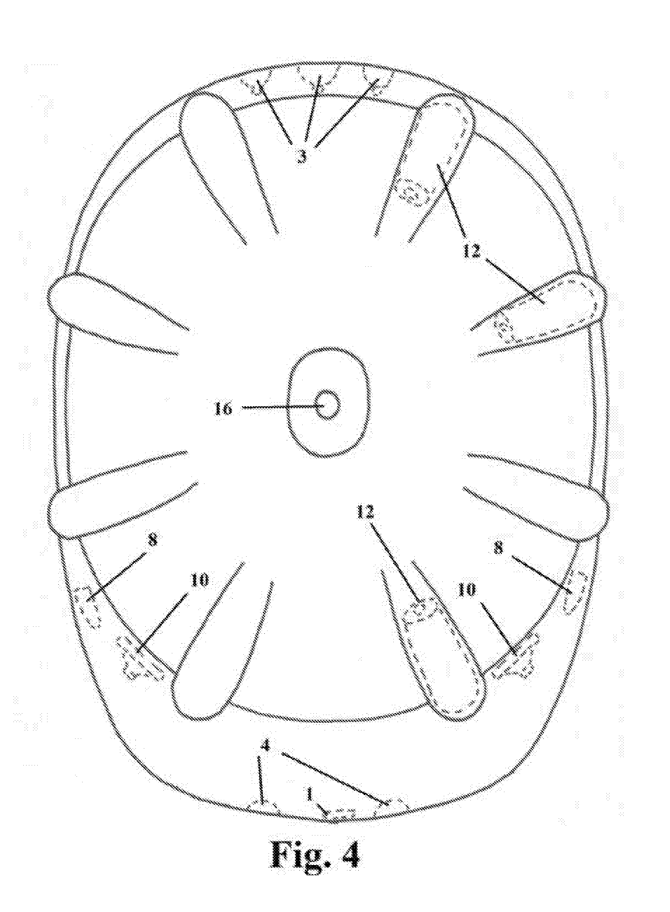

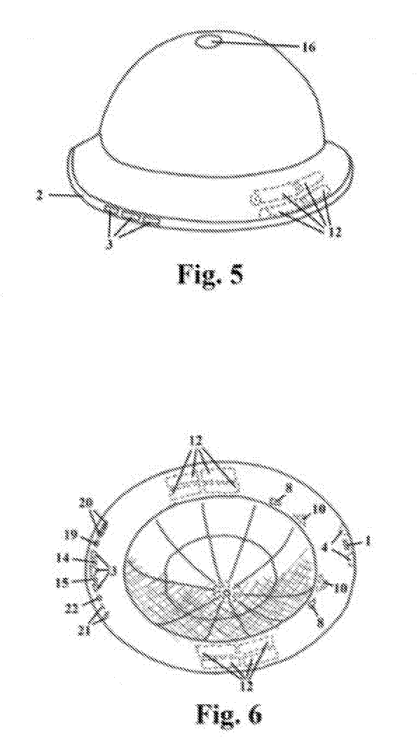

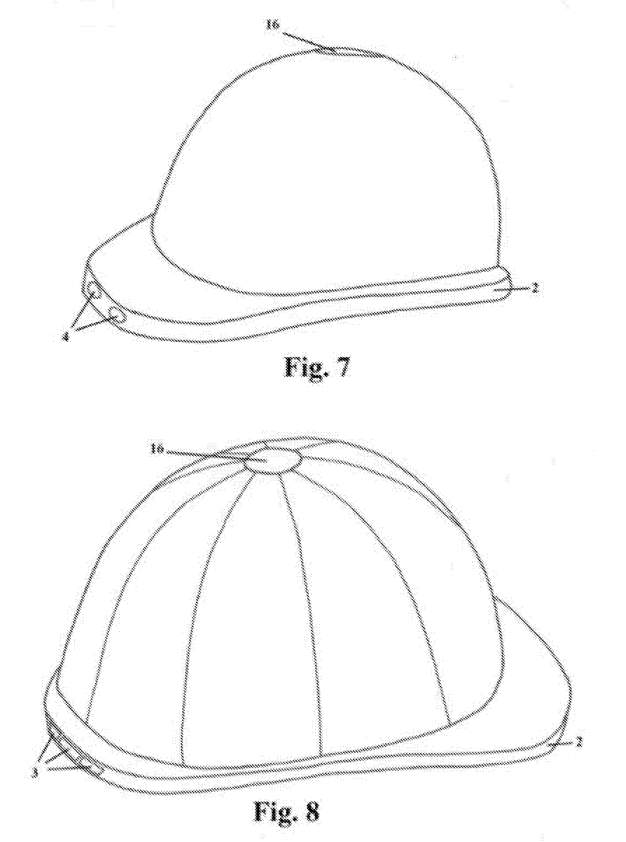

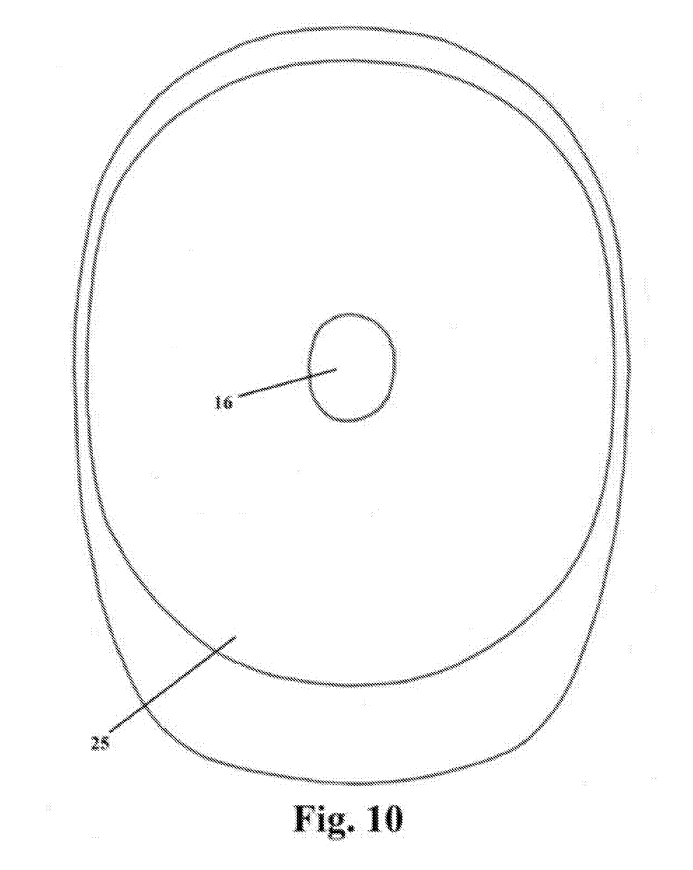

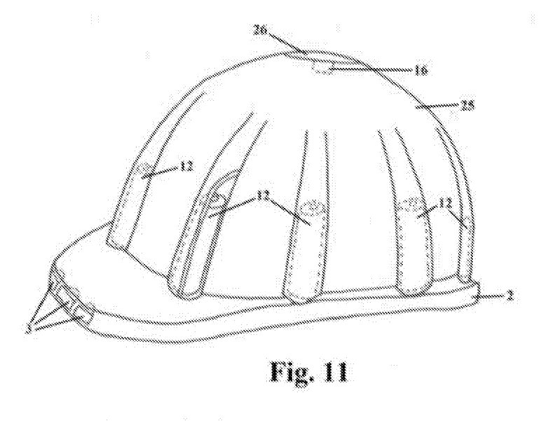

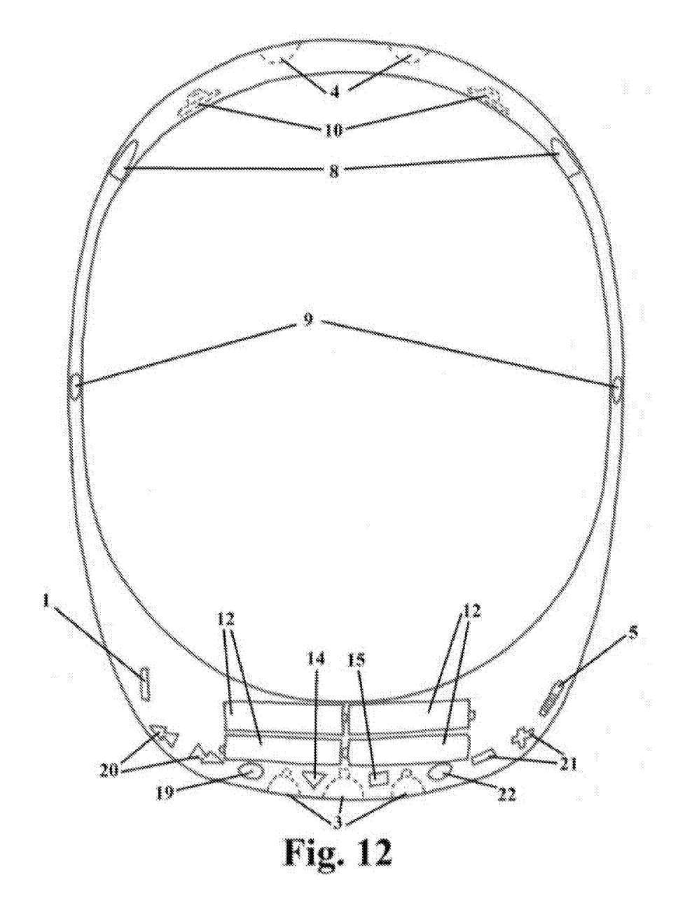

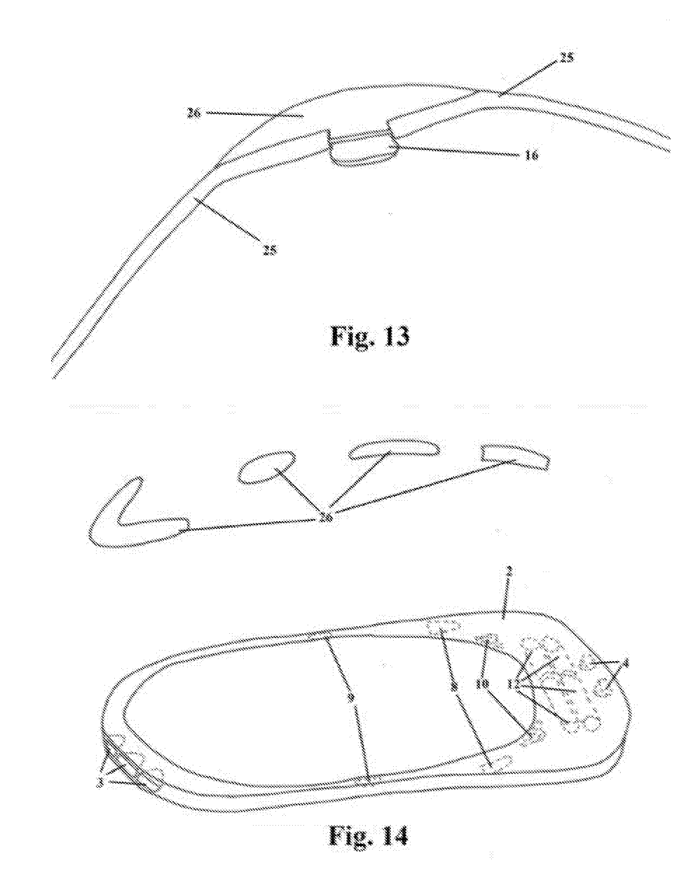

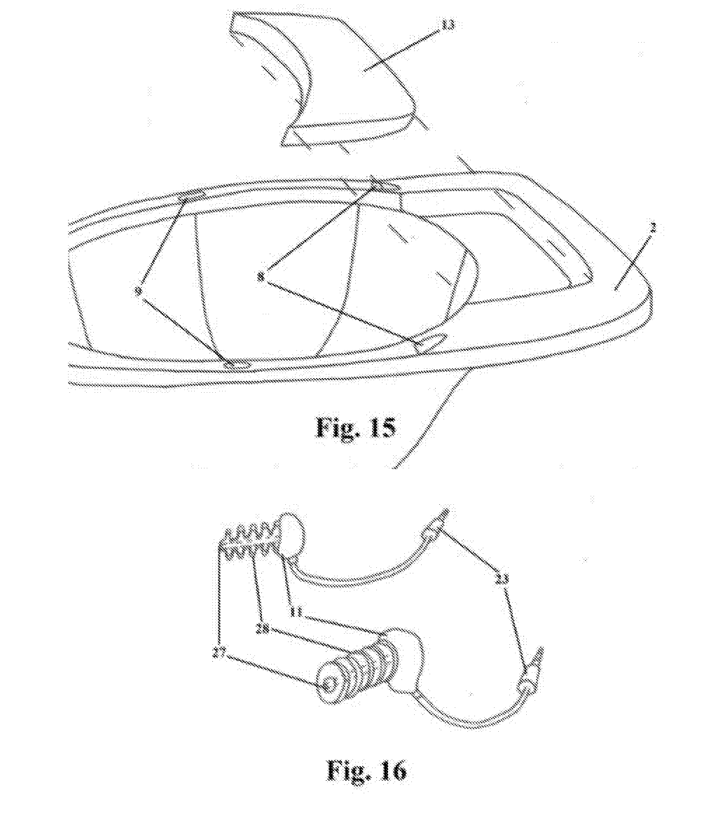

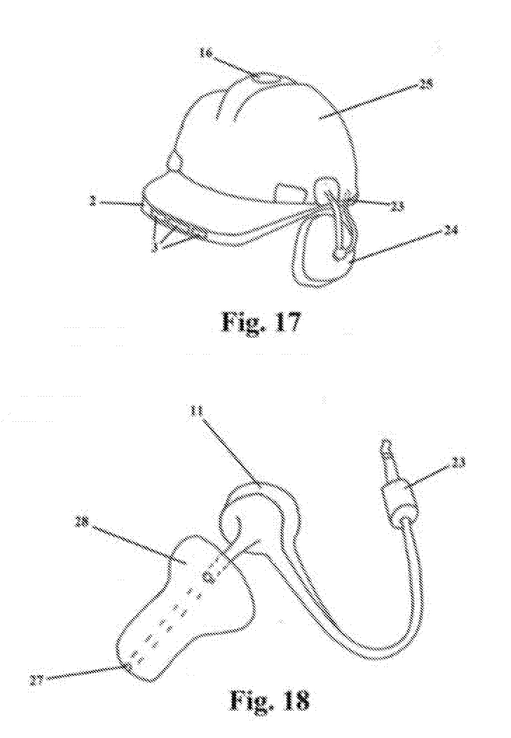

The shell 25 of the hardhat is not limited to any one particular design. The three designs drawn are the heavy duty design (FIGS. 1-4 and 11), a smooth top design (FIGS. 7-10, 12, and 15), and a full brimmed hard hat design (FIGS. 5 and 6). All designs are sleek and contain the lights, batteries, and Bluetooth within its initial shape. Different shell designs have different locations for batteries, USB charging port 1, and possibly any other item necessary to maintain a structurally sound hard hat without bulky boxes or lights protruding out of the hardhat itself

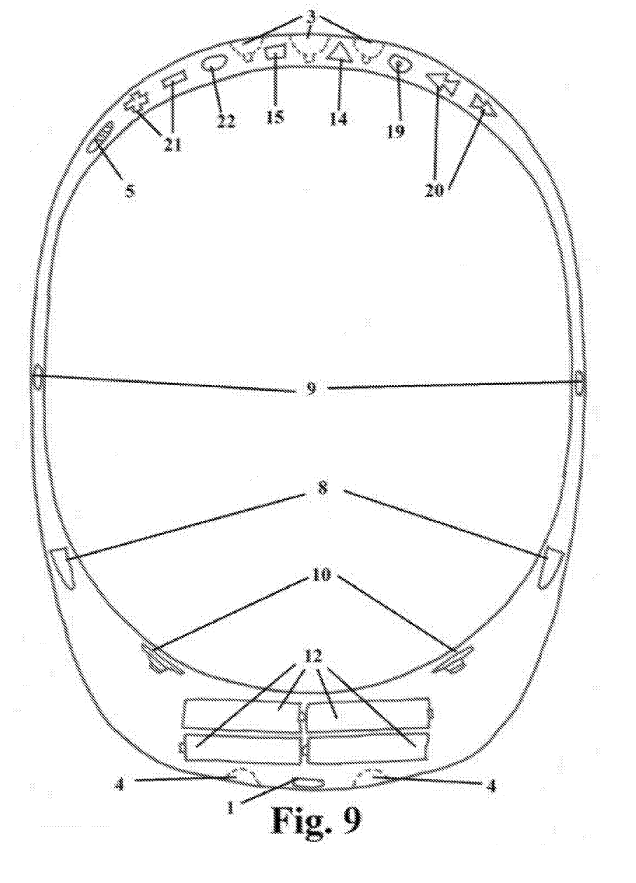

The sub-shell 2 is made out of but not limited to rubber, silicone or the substantially comparable material in which its rugged shape can withstand normal jobsite abuse. The integrated components are a considerable distance from the outer edge of the sub-shell 2 that plastic pieces shaped like the controls are inserted into the said sub-shell 2. The plastic pieces or similar material act as an extension of the individual switches while elevating the surface, making the raised button symbols FIG. 9 protrude outwardly enough that an individual can feel the differences in the buttons while wearing gloves, and the sub-shell 2 has enough flexibility to permit the use of the buttons with ease. The sub-shell 2 thickness permits the capacity to house the integrated components comprised of: front LED lights 3, the rear red LED strobe lights 4, the Bluetooth system, the controls for the lighting and Bluetooth, the ear bud jack connection 8, ear bud magnetic holders 9, speakers 10.

The controls are molded within the sub-shell 2 and control the lights and blue tooth functions.

The controls (FIG. 9) for the strobe lights are a push button on/off switch 14. Strobe lights consist of, but are not limited to, two rear red strobe lights 4 and one white strobe at the top 16. Two LED strobe lights are at the rear or the hat 4, molded within the sub-shell and are in connection with the LED strobe light at the top 16. The rear strobe LED 4 make a few quick bursts of light before sequentially lighting the top LED strobe 16, which then makes a few quick bursts before starting back to the beginning of the cycle.

The front LED lights 3 have, but not limited to, three high powered LED lights. The center one has a different lens than the outside two, which creates different lighting options. The front LED push button switch 15 functions in sequence: center LED, then two outside LED's, then all three LED's, and then off position.

The Bluetooth system contained in the sub-shell 2 contains the controls, microphone, speakers 10, ear bud jack connections 8, magnetic ear bud holders 9, and blue tooth. The blue tooth has an on/off switch 5. The blue tooth can be paired with any blue tooth enabled smart phone. The controls (FIG. 9) consist of a play/pause button 19, forward/reverse button 20, volume controls 21, and a talk button for phone calls 22. The speakers 10 are defaulted unless other ear buds 11 or head phones 24 are being used. The ear buds 11 can be inserted into the jacks connectors 8 and then it will bypass the speakers 10. The ear buds 11 have a magnet within its shell to magnetically grab hold of its mate, ear bud magnetic holders 9, located in the sub-shell 2.

Ear Buds 11 are engineered to protect from high decibel construction noise while enabling sound to travel from ear bud to ear through a hollowed shaft 27 within ear buds 11.

Ear muffs 24 are from the same concept, integrated to coincide and used with the hardhat the ear muffs 24 protect from high decibel noise and permit sound at moderate levels to be heard from speakers within.

The power supply consists of, but not limited to, lithium ion rechargeable batteries 12. Some designs permit a removable battery pack 13 while others have a designated location relating to its design and can be recharged by a USB port 1, or substantially similar connection. The battery pack 13 will have a separate charger to charge one pack while another is being used. The rechargeable batteries 12 have access to be changed in the future if needed.

Charging devices can be, but not limited to, wireless. Wireless charging devices 29 whether used on a desktop or wall mounted hat racks with hooks 31 will increase productivity, cleanliness and efficiency on jobsite. The wireless charging hat rack station 29 shown with present invention 30 hanging on hooks 31 either overnight or during a jobsite meeting. (FIG. 19)

The retrofit unit (FIG. 14) is designed for popular hardhats typically being used so that the sub-shell 2 and high impact resistant plastic 26 conforms to the particular hardhat. The retrofit unit (FIG. 14) consists of the sub-shell 2 which contains; blue tooth system, controls for Bluetooth and lighting, front LED lights 3, rear red strobe lights 4, speakers 10, ear bud jack connections 8 and ear bud magnetic holders 9. Top LED strobe 16 can be installed to an existing hardhat with an integrated High impact resistant plastic 26 for each individual hard hat.

The descriptive details expressed hereby inform one who is relatively skilled and knowledgeable in such devices that one or more elements in this disclosure can be replaced by other materials or deviated from said details and still stay within its capacity and essence of this present invention.

The extent of these descriptions shall be explained only in the context of the appended claims hereby disclosing the inventor believes that the claimed subject matter is what is intended to be patented.

What is claimed is:

1. An ANSI Approved Rechargeable, Lighted, Bluetooth Hardhat comprising: A. a protective shell, said shell can consist of, but not limited to, fiberglass, carbon fiber, high impact resistant plastic, and or another substantially comparable material; B. at least, but not limited to, one set of Lithium Ion rechargeable batteries, and charging device; C. a LED strobe light at the top of the hard hat, wherein said LED strobe light has a protective high impact resistant cover over the LED and hardhat structure; D. ear buds and or ear muffs designed to limit construction noise; E. a sub-shell formed on the bottom of the hardhat, whereas said sub-shell comprises of: controls for the lighting and Bluetooth system; Bluetooth system components; front LED lights, wherein said LED lights have lenses and a reflective housing to direct light efficiently; rear red strobe LED lights, that are located only in the rear.

2. The device in claim 1 in which said Lithium Ion rechargeable batteries shall conform to each different protective shell design of the hard hat itself, wherein said rechargeable battery locations, differ from design to design, shall not be notably detected the whereabouts of the exact location from a distance until further closer observation. That each location shall be within the said protective shell or said sub-shell.

3. The device in claim 2 in which said Lithium Ion rechargeable batteries can comprise of an integrated removable battery pack configured in respect to the design of the hardhat, wherein said removable battery pack shall have a separate charging device while multiple battery packs can be utilized.

4. The device in claim 1 in which said charging device can also be wireless, said wireless charger can be a tablet set on top of desks or incorporate a hat rack and mount on the wall. Said wireless hat rack could be larger for a multiple hard hat charging station.

5. The device in claim 1 in which said sub-shell is a molded image of the said protective shell, creating impeccable cohesion, wherein said sub-shell thickness is that to which allow the integrated components comprised of; front LED lights, rear red strobe LED lights, Bluetooth components, speakers, microphone, USB charging port, ear bud holders, ear bud jacks, controls for lighting and Bluetooth system.

6. The device in claim 5 in which said ear bud holders employ magnets within a specific location which clip the ear bud in place while not in use.

7. The device in claim 5 in which said integrated components create under brim lighting and sound, whereas, lighting closer to the line of sight, and sound closer to the ears, generate superior lighting and sound quality, focusing the light and sound where needed, and remaining protected from the elements or physical damage by the said protective shell.

8. The device in claim 5 in which said integrated components are mounted with considerable distance between that of the outer edge of the said controls for lighting and Bluetooth system that solid plastic or similar materials be placed within said sub-shell, establishing an extension for precise switch depressions.

9. The device in claim 5 in which said sub-shell is flexible for ease in pushing said controls and yet firm to hold form and integrity, wherein said sub-shell can consist of but not limited to rubber, silicone, and or substantially comparable material.

10. The device in claim 8 in which said controls for lighting and Bluetooth system have an elevated surface wherein discernment between said controls can be established while wearing gloves.

11. The device in claim 10 in which said controls for lighting and Bluetooth system comprise of: an on/off switch for front LED, an on/off switch for the top and red rear strobe LED's, an on/off switch for Bluetooth system, play/pause button, forward/reverse buttons, volume controls and talk button.

12. The device in claim 1 in which said rear red strobe lights and said top strobe light work in conjunction with one another whereas a couple short strobe bursts of light from one set of strobe lights then a few short strobe bursts from the other and then repeat the cycle.

13. The device in claim 1 in which said ear buds spherical in shape uses hearing protection ear plugs with a hollowed out shaft within the center line of the axis producing a pathway for sound to travel from speakers to ear.

14. The device in claim 1 in which said ear muffs are specifically designed to attach to hard hat and plug into ear bud jacks while blocking out unwanted construction decibel noise and clear unobstructed sounds travel from speakers within.

15. A retrofit unit for retrofitting an existing hard hat to include LED lights and Bluetooth system, said retrofit unit comprising;
a sub-shell that is formed to attach to other popular designed and used hardhats, wherein said sub-shell thickness is that to which allow the integrated components comprised of; Front LED lights, rear red LED strobe lights, rechargeable batteries, speakers, ear bud jack connection, magnetic ear bud holders, USB charging port, and controls for the lighting and Bluetooth system; a LED strobe light can be applied to the top of the hardhat, said LED strobe light has a protective high impact resistant cover, specifically molded for said popular designed and used hardhats, that can be installed over the LED and hardhat structure; ear buds and or ear muffs engineered to limit construction noise; and a charging device.

16. The retrofit unit as defined in claim 15 in which said front LED lights have lenses and a reflective housing to direct light efficiently.

17. The retrofit unit as defined in claim 15 in which said rechargeable batteries comprising of; at least but not limited to, one set of Lithium Ion rechargeable batteries, shall conform to each different protective shell design of the said existing hard hat itself, wherein rechargeable battery locations, differ from design to design, shall not be notably detected the whereabouts of the exact location from a distance until further closer observation. That each location shall be within the said sub-shell.

18. The retrofit unit as defined in claim 17 in which said Lithium Ion rechargeable batteries can comprise of an integrated removable battery pack configured in respect to the design of the hardhat, wherein said removable battery pack shall have a separate charging device where multiple battery packs can be utilized.

19. The retrofit unit as defined in claim 15 in which said integrated components create under brim lighting and sound, whereas, lighting closer to the line of sight, and sound closer to the ears, generate superior lighting and sound quality, focusing the light and sound where needed, and remaining protected from the elements or physical damage by the said protective shell.

20. The retrofit unit as defined in claim 15 in which said integrated components are mounted with considerable distance between that of the outer edge of the said controls for lighting and Bluetooth system that solid plastic or similar materials be placed within said sub-shell, establishing an extension for precise switch depressions.

21. The retrofit unit as defined in claim 15 in which said sub-shell is flexible for ease in pushing said controls and yet firm to hold form and integrity, wherein said sub-shell can consist of but not limited to rubber, silicone, and or substantially comparable material.

22. The retrofit unit as defined in claim 15 in which said controls for lighting and Bluetooth system have an elevated surface wherein discernment between said controls can be established while wearing gloves.

23. The retrofit unit as defined in claim 22 in which said controls for lighting and Bluetooth system comprise of: an on/off switch for front LED, an on/off switch for the top and red rear strobe LED's, an on/off switch for Bluetooth system, play/pause button, forward/reverse buttons, volume controls and talk button.

24. The retrofit unit as defined in claim 15 in which said rear red strobe lights and said top strobe light work in conjunction with one another whereas a couple short strobe bursts of light from one set of strobe lights then a few short strobe bursts from the other and then repeat the cycle.

25. The retrofit unit as defined in claim 15 in which said charging device can also be wireless, said wireless charger can be a tablet set on top of desks or incorporate a hat rack and mount on the wall. Said wireless hat rack could be larger for a multiple hard hat charging station.

26. The retrofit unit as defined in claim 15 in which said ear buds spherical in shape uses hearing protection ear plugs with a hollowed out shaft within the center line of the axis producing a pathway for sound to travel from speakers to ear.

27. The retrofit unit as defined in claim 15 in which said ear muffs are specifically designed to attach to hard hat and plug into ear bud jacks while blocking out unwanted construction decibel noise and clear unobstructed sounds travel from speakers within.
